(19) United States
(12) Patent Application Publication
(10) Pub. No.: US 2026/0024740 A1
(43) Pub. Date: Jan. 22, 2026

(54) METHOD OF CONTINUOUS TOTAL LIQUID-PHASE SULFIDE-BASED SOLID STATE BATTERY ELECTRODE SLURRY COATING

(71) Applicant: GM Global Technology Operations LLC, Detroit, MI (US)

(72) Inventors: Yong Lu, Shanghai (CN); Zhe Li, Shanghai (CN); Haijing Liu, Shanghai (CN)

(21) Appl. No.: 18/786,995

(22) Filed: Jul. 29, 2024

(30) Foreign Application Priority Data
Jul. 19, 2024 (CN) 202410976852.8

(51) Int. Cl. H01M 4/04; H01M 4/02; H01M 4/38; H01M 4/62; H01M 4/66; H01M 4/75; H01M 10/0562

(52) U.S. Cl. CPC H01M 4/0404; H01M 4/0471; H01M 4/386; H01M 4/625; H01M 4/661; H01M 4/75; H01M 10/0562; H01M 2004/027; H01M 2300/0068

(57) ABSTRACT

A method of making a solid-state electrode sheet is provided. The method includes mixing precursors capable of chemically reacting to form a target solid-state electrolyte (SSE) together with one or more of a binder, an electrode active material, and a conductive carbon in a solvent to form a coating slurry. The precursors a undergoes a chemical reaction in the solvent to form the target SSE. The coating slurry is applied onto a current collector. The solvent is evaporated from the coating slurry on the current collector, thereby producing a solid-state electrode sheet having a target SSE. The precursors may be lithium sulfide (Li₂S) and phosphorus pentasulfide (P₂S₅) reacting in a tetrahydrofuran (THF) solvent to produce a sulfide-base SSE such as Li₃PS₄.

### INTRODUCTION

The present disclosure relates to a method of making a sulfide solid-state battery, and more particularly to a method of total liquid-phase sulfide-based solid state battery electrode slurry coating.

Rechargeable lithium-on batteries have the ability to hold a relatively high energy density, a relatively low internal resistance, and a low self-discharge rate when not in use as compared to older types of rechargeable batteries such as nickel metal hydride, nickel cadmium, or lead acid batteries. Electric and hybrid vehicles predominantly use rechargeable lithium ion batteries as a dependable power source due to the lithium ion batteries' ability to undergo repeated power cycling over their useful lifetimes.

A solid-state battery is an electrical battery that uses a solid-state electrolyte (SSE) for ionic conductions between the electrodes and potentially offers higher energy density than the typical lithium-ion batteries having liquid or gel polymer electrolytes. An all-solid-state battery (ASSB) is a battery that has no gas and no liquid in it, and all components making up the battery, including the electrodes and the electrolytes, exist in a solid state. Sulfide-based ASSBs are promising next-generation batteries for electric vehicles in virtue of their potential advantages of enhanced safety, high energy density and power capability.

Manufacturing of high performance sulfide-based ASSBs faces challenges with respect to time, material, and cost. In a particular example, sulfide-based SSEs are synthesized prior to slurry mixing. The synthesizing of sulfide-based SSEs include the steps of transforming and mixing the sulfide-based electrolyte precursors using a ball milling process followed by a sintering process to achieve a targeted relatively high ionic conductivity. The dried synthesized sulfide-based SSE is then mixed with solvents, binders, active materials, and other components to form an electrode slurry to coat electrode sheets. The amount of time required to mill the sulfide-based SSE precursors, sintering, and mixing into a slurry is labor and time consuming, which may be greater than 24 hours, thus resulting in a low production rate. The long-time milling process also consumes large quantity of energy that brings about the higher processing cost.

Thus, while convention methods of making sulfide-based ASSBs achieve their intended purpose, there is a need for a more efficient and cost-effective process for making a sulfide-based SSE electrode for an ASSB.

### SUMMARY

According to several aspects, a method of making a solid-state electrode is disclosed. The method includes selecting precursors capable of chemically reacting to form a target solid-state electrolyte (SSE), mixing the selected precursors into a solvent to form a coating slurry, applying the coating slurry onto a current collector, and evaporating the solvent from the coating slurry on the current collector thereby leaving the target SSE coating on the current collector. The precursors reacts in the solvent to form the target SSE in the coating slurry, and therefore does not need to be subjected to a ball milling process to produce the SSE beforehand.

In an additional aspect of the present disclosure, the coating slurry includes 30 weight percent (wt %) to 50 wt % of a solid content, which includes the selected precursors and one or more of a binder, an electrode active material, and a conductive carbon.

In another aspect of the present disclosure, the solid content includes 8.0 wt % to 38 wt % of the selected precursor, 2.0 wt % to 10 wt % of the binder, 60 wt % to 90 wt % of the electrode active materials, and 1 wt % to 8 wt % of conductive carbon/

In another aspect of the present disclosure, the selected precursors are lithium sulfide (Li₂S) and phosphorus pentasulfide (P₂S₅) and the target SSE is Li₃PS₄. The Li₂S and P₂S₅ includes a molar ratio of from 7:3 to 3:1.

In another aspect of the present disclosure, the method further includes mixing Li₂S and LiX into the solvent, wherein X is one of CI, Br, and I. Li₂S and LiX react in the solvent to form an argyrodite-type electrolyte. The molar ratio of Li₂S to LiX is 1:1.

In another aspect of the present disclosure, the method further includes mixing LiX, Li₂S, and MS₂ into the solvent, wherein M is selected from a group consisting of Si, Sn, and Ge. LiX, Li₂S, and MS₂ react in the solvent to form lithium Si/Ge/Sn-phosphor Sulfo-Halogen (LiMPSX).

According to several aspects, a method of making a sulfide-based solid-state electrode is provided. The method includes dissolving a binder in a first solvent to produce a binder solution, mixing sulfur-electrolyte precursors in a second solvent for greater than 2 hours, wherein the sulfur-electrolyte precursors reacts in the second solvent to produce a sulfur-electrolyte suspension, mixing the binder solution with the sulfur-electrolyte suspension to form a binder sulfur-electrolyte suspension, mixing a silicon powder and a third solvent into the binder sulfur-electrolyte suspension to form an electrode coating slurry, applying the coating slurry onto a current collector; and drying the coating slurry on the current collector at a temperature between 60° C. to 160° C., thereby leaving a sulfur-electrolyte coated current collector. The sulfur-electrolyte precursors includes Li₂S and P₂S₅. The first solvent, the second solvent, and the third solvent comprises tetrahydrofuran (THF).

In an additional aspect of the present disclosure, the method further includes mixing a conductive carbon in the electrode slurry.

In another aspect of the present disclosure, the molar ratio of Li₂S:P₂S₅ is between 7:3 to 3:1.

In another aspect of the present disclosure, the coating slurry includes a total solid content of between 30 wt % to 50 wt %. The solid content includes the Li₂S and P₂S₅, the binder, the Si powder, and the conductive carbon. The total solid content includes 15 wt % to 30 wt % of the Li₂S and P₂S₅; 65 wt % to 80 wt % of the Si powder; 3.0 wt % to 7 wt % of the binder; and 2 wt % to 5 wt % of the conductive carbon.

According to several aspects, a method of making a sulfide-based solid-state anode electrode is provided. The method includes chemically reacting electrolyte precursors Li₂S and P₂S₅ in a solvent to produce a sulfide-based electrolyte, wherein the solvent is Styrene-ethylene-ethylene-propylene-styrene (SEEPS), mixing in a Si powder to the solvent, adding additional solvent to form an electrode coating, applying the electrode coating to a copper foil, and drying the electrode coated copper foil at a temperature between 80° C. to 160° C., thereby producing an electrode sheet having a sulfide-based solid-state electrolyte.

In an additional aspect of the present disclosure, Si, SEEPS, and Li₂S and P₂S₅ includes a weight ratio of 70:5:25.

In another aspect of the present disclosure, Li₂S and P₂S₅ includes a mole ratio of 3:1 and are not subjected to ball milling.

In another aspect of the present disclosure, the electrode sheet having the sulfide-based solid-state electrolyte defines an anode electrode sheet.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic representation of a cross-section of a rechargeable sulfide-based solid-state battery, according to an exemplary embodiment;

FIG. 2 is a flow block diagram of a first embodiment of a method of total liquid-phase sulfide-based solid state battery electrode slurry coating, according to an exemplary embodiment, according to an exemplary embodiment;

FIG. 3 is a flow block diagram of a second embodiment of the method of total liquid-phase sulfide-based solid state battery electrode slurry coating, according to an exemplary embodiment, according to an exemplary embodiment;

FIG. 4 is a flow block diagram of a third embodiment of the method of total liquid-phase sulfide-based solid state battery electrode slurry coating, according to an exemplary embodiment, according to an exemplary embodiment;

FIG. 5 is a flow block diagram of a fourth embodiment of the method of total liquid-phase sulfide-based solid state battery electrode slurry coating, according to an exemplary embodiment, according to an exemplary embodiment; and

FIGS. 6A, 6B, and 6C are performance graphs of a sulfide-based solid-state battery having an electrode made by the Method of FIG. 3.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers, and/or sections. These elements, components, regions, layers, and/or sections should not be limited by these terms. These terms may be only used to distinguish one element, component, region, layer or section from another region, layer, or section. Terms such as “first,” “second,” and other numerical terms do not imply a sequence or order unless clearly indicated by the context. Thus, a first element, component, region, layer, or section discussed below could be termed a second element, component, region, layer, or section without departing from the teachings of the example configurations.

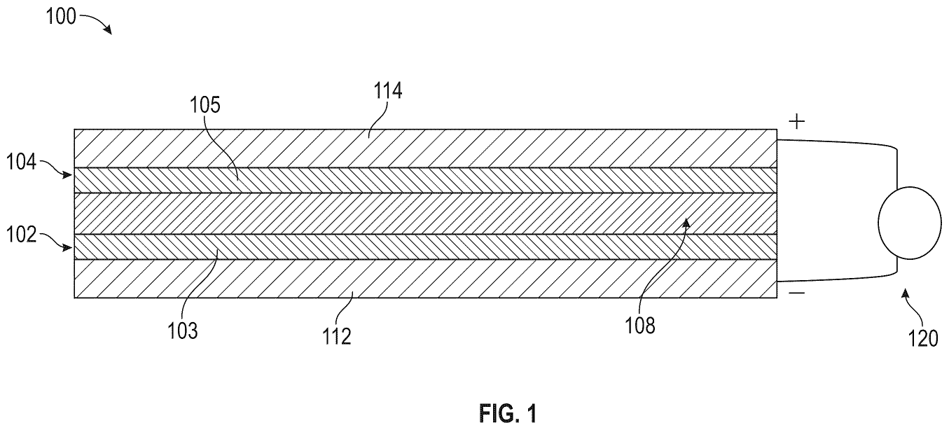

FIG. 1 is a diagrammatic representation of a rechargeable solid-state battery, generally indicated by reference number 100. In a non-limiting example, the SSB 100 may be that of an all-solid-state battery (ASSB). The SSB 100 includes a negative electrode 102, a positive electrode 104, and a separator layer 108 disposed between the negative electrode 102 and positive electrode 104. The separator layer 108 includes a solid-state electrolyte material suitable for conducting lithium ions between the negative electrode 102 and the positive electrode 104.

The negative electrode 102 includes a lithium accepting host material 103 and the positive electrode 104 includes a lithium-based active material 105 that can store lithium ions at a higher electric potential than the lithium accepting host material 103 of the negative electrode 102. One or both of the negative electrode 102 and positive electrode 104 may further include a sulfur compound such as metal sulfides, sulfide-based electrolytes, and other lithium conductive sulfur compounds.

The positive electrode 104 is also referred to as a cathode 104 due to its higher electrochemical potential and the negative electrode 102 is also referred to as an anode 102 due to its relative lower electrochemical potential. Each of the negative electrode 102 and the positive electrode 104 is accommodated by a respective current collector 112, 114. The current collectors 112, 114 may be connected by an interruptible circuit 120 that allows an electrical current to pass between the negative and positive electrodes 102, 104 to electrically balance the related migration of the lithium ions between the negative and positive electrodes 102, 104 through the separator layer 108. The current collectors 112, 114 may be formed of a metallic foil. The metallic foil may be formed from electrically conductive metals such as copper for the negative electrode and aluminum for the positive electrode.

A traditional method of preparing a coating slurry for coating a current collector to form an electrode requires preparing a solid-state electrolyte (SSE) in advance and then mixing the prepared SSE with solvents to form the coating slurry. Preparing the SSE in advance typically includes ball milling precursors to form an electrolyte and sintering the electrolyte to produce SSE particles having the desired ionic conductivity. The SSE particles are then blended with a solvent to form the coating slurry. The coating slurry is applied onto a current collector and the solvent is then evaporated to produce an electrode sheet have a SSE.

Ball milling is a mechanical process that involves the rotation of a drum containing grinding media, typically ceramic balls, at a high speed. Sulfide-based electrolyte precursors such as lithium sulfide (Li₂S), phosphorus pentasulfide (P₂S₅), lithium chloride (LiCl), and solvents are loaded into the drum. As the drum rotates, the grinding media collide with the sulfide-based electrolyte precursors causing them to break down and reduce in size. The sulfide-based electrolyte precursors chemically react with each other under the heat generated by the ball milling process to form a sulfide-based electrolyte mixture. The typical required milling time is greater than 24 hours.

Following ball milling, the sulfide-based electrolyte mixture is sintered at about 550° C. to achieve a sulfide-based solid-state electrolyte (SSE) having an ionic conductivity greater than E-3 mS/cm. The sulfide-based SSE is then blended with solvents, binder materials, and active materials to form an electrode coating slurry, also referred to as an electrode slurry or a coating slurry. The electrode slurry is coated onto a current collector. The solvents in the electrode slurry is evaporated leaving the sulfide-based SSE having a conductivity of E-4 mS/cm. A shortcoming of this traditional method is the required time and energy required for the ball milling process and sintering of the milled material. Another shortcoming is the addition of solvents to the milled material to form the electrode slurry, which reduces the conductivity of the sintered solid-state electrolyte, for example, from E-3 mS/cm to E-4 mS/cm.

In the ball milling process, heat generated during the ball milling process causes the electrolyte precursors to undergo a solid-solid reaction. Solid-solid reaction is an endothermic reaction requiring significant breaking of bonds and reorganization of the precursors to form electrolyte particles. The present disclosure provides a simply and cost-effective method of continuous total liquid-phase sulfide solid state battery electrode slurry coating. The present disclosed method eliminates the steps of ball milling and sintering in the making of an electrode slurry coating that has a similar, if not superior, conductivity to electrode coatings made with the traditional method of ball milling.

An overview of the method of continuous total liquid-phase sulfide solid state battery electrode slurry coating (Method 200) includes making an electrode coating slurry, coating a current collector with the electrode coating slurry, and evaporating the solvent from the coated current collector leaving a solid-state electrolyte (SSE) coated current collector, also known as an electrode sheet. Making the electrode coating slurry, or coating slurry, includes mixing solid contents that includes precursors for forming a target electrolyte and at least one of a binder, an active material, and a conductive carbon in a solvent and adjusting the solid contents to form an electrode slurry. Sufficient solvent is added to the mixture to form an electrode slurry having an effective consistency for coating a current collector. The solvent triggers a chemical reaction of the precursors to produce a target electrolyte in the solvent. In a non-limiting example, the target electrolyte is a sulfide-based electrolyte Li₆PS₅Cl produced by the chemical reaction of the precursors Li₂S, P₂S₅, and LiCl in the solvent. The solvent is evaporated from the coating slurry leaving behind a sulfide-based SSE.

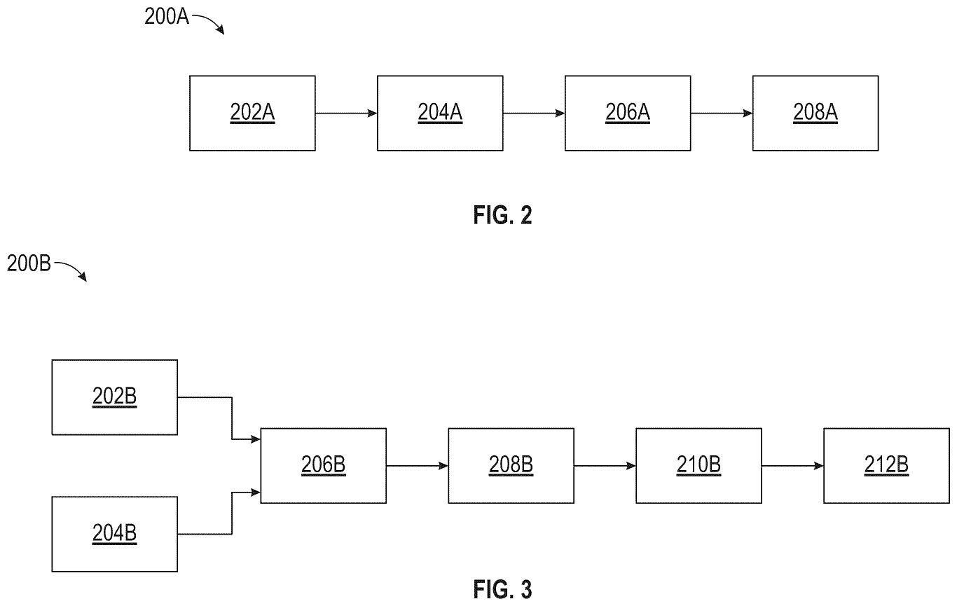

FIG. 2 shows a block diagram of a first embodiment of Method 200. The first embodiment of Method 200 is referred to as Method 200A. At Block 202A, a sufficient amount of binder is dissolved in a solvent to form a Binder Solution. Moving to Block 204A, selected precursors for a target SSE are added to the Binder Solution and mixed for greater than 2 hours to form a Binder Sulfur-Electrolyte Suspension. Moving to Block 206A, an electrode active material, such as silicon (Si), and a sufficient amount of additional solvent are added to the Binder Sulfur-Electrolyte Suspension to form a coating slurry having 30 to 50 weight percent (wt %) of total solid content and a remaining 70 to 50 wt % of solvent. Moving to Block 208A, a planar metallic foil, i.e. current collector, is coated with the coating slurry. The coating slurry on the metallic foil is dried at a temperature between about 60° C. to 200° C., preferably between about 80° C. to 160° C., thereby producing an electrode sheet having a SSE.

FIG. 3 shows a block diagram of a second embodiment of Method 200. The second embodiment of Method 200 is referred to as Method 200B. At Block 202B, a sufficient amount of a binder is dissolved in a first solvent to form a Binder Solution. Concurrently, at Block 204B, a sufficient amount of second solvent is added to a predetermined amount of sulfur-electrolyte precursors and mixed for greater than 2 hours, during which the precursors react to produce a sulfur-electrolyte, to form a Sulfur-Electrolyte Suspension. Moving to Block 206B, the Binder solution is mixed with the Sulfur-Electrolyte Suspension to form a Binder Sulfur-Electrolyte Suspension. Moving to Block 208B, a predetermined amount of electrode active material and solvent are added to the Binder Sulfur-Electrolyte Suspension. Moving to Block 210B, the Binder Sulfur-Electrolyte suspension, Si, and solvent are sufficiently mixed with a third solvent to form a coating slurry. The first, second, and third solvents may be the same type of solvent. Moving to Block 212B, a planar metallic foil, i.e. current collector, is coated with the coating slurry. The coating slurry on the metallic foil is dried at a temperature between about 60° C. to 200° C., preferably between about 80° C. to 160° C., thereby producing an electrode sheet having a SSE.

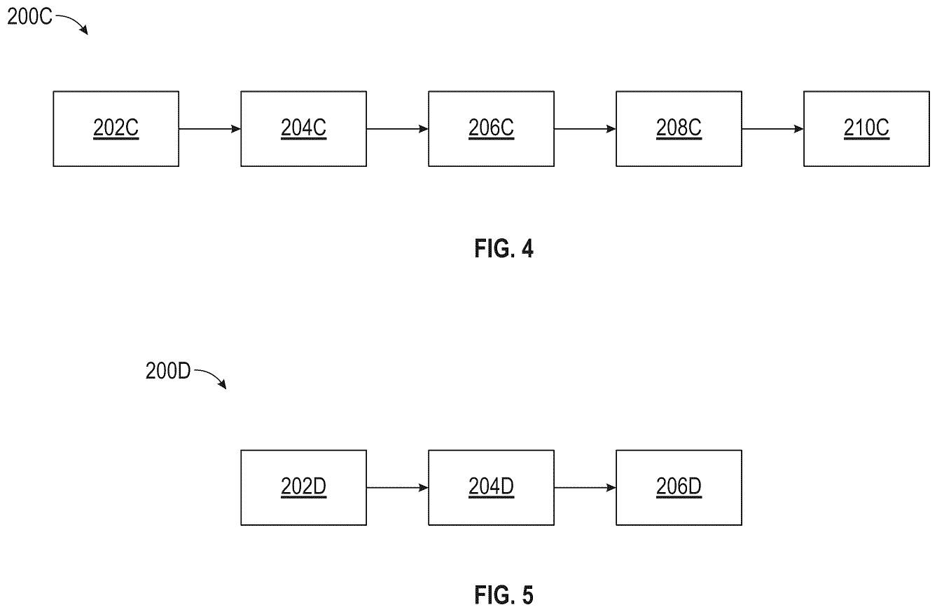

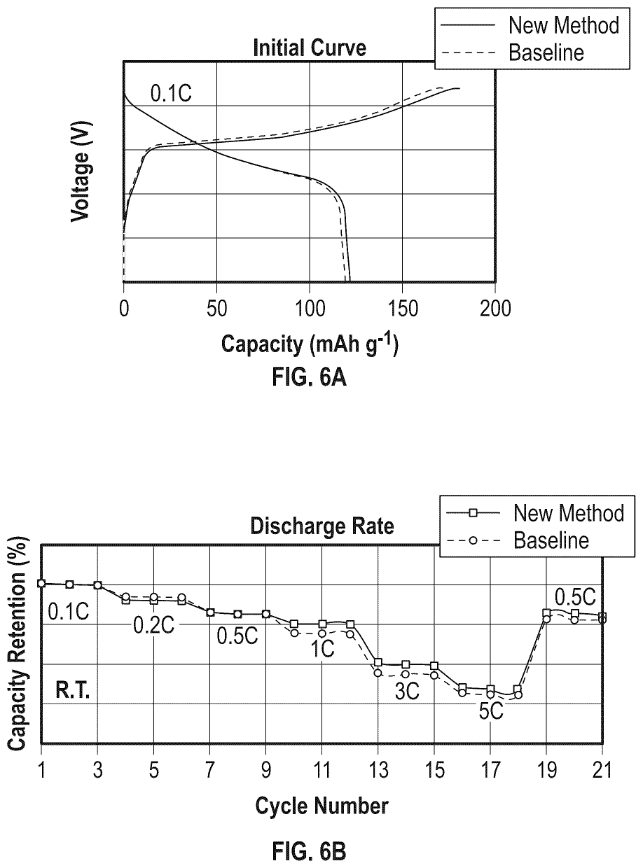

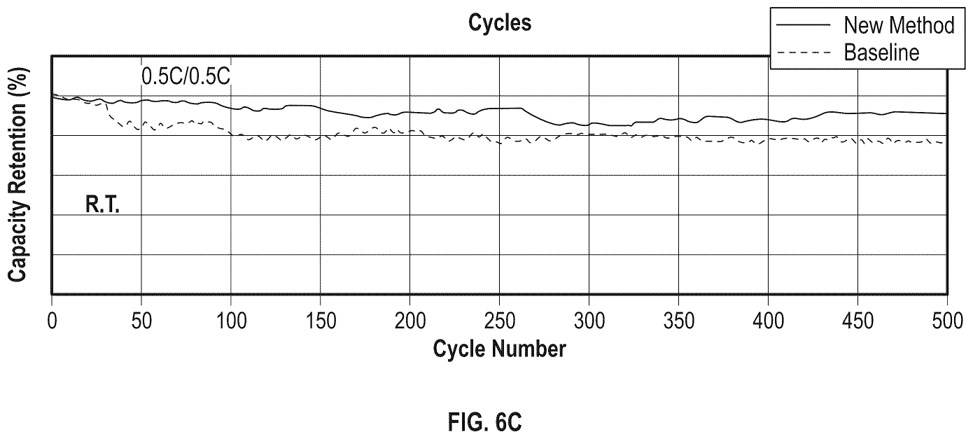

FIG. 4 shows a block diagram of a third embodiment of Method 200. The third embodiment of Method 200 is referred to as Method 200C. At Block 202C, a sufficient amount of solvent is added to dissolve a predetermined amount of binder to form a Binder Solution. At Block 204C, a sufficient amount of electrode active material, such as Si powder, and solvent is added to form Binder/Si suspension. Moving to Block 206C precursors Li₂S, P₂S₅, etc., and additional solvent are added to the Binder/Si suspension. Moving to Block 208C, the Binder/Si suspension, precursors, and solvent are sufficiently mixed to form a coating slurry. Moving to Block 210C, a planar metallic foil, i.e. current collector, is coated with the coating slurry. The coating slurry on the metallic foil is dried at a temperature between about 60° C. to 200° C., preferably between about 80° C. to 160° C., thereby producing an electrode sheet having a SSE.

FIG. 5 shows a block diagram of a fourth embodiment of Method 200. The fourth embodiment of Method 200 is referred to as Method 200D. At Block 202D, binders, Si, and precursors (Li₂S, P₂S₅, etc.) are introduced into a solvent followed by greater than 2 hours of mixing to form the coating slurry. The coating slurry on the metallic foil is dried at a temperature of between about 60° C. to 200° C., preferably between 80° C. to 160° C. Moving to Block 206D, a planar metallic foil, i.e. current collector, is coated with the coating slurry. The coating slurry on the metallic foil is dried at a temperature between about 60° C. to 200° C., preferably between about 80° C. to 160° C., thereby producing an electrode sheet having a SSE.

For each of the embodiments of the Method 200 (200A, 200B, 200C, 200D), precursors for a target electrolyte in a predetermined molar ratio are mixed in a solvent to react to produce the target electrolyte in the solvent. The solvent triggers and mediates the chemical reaction of the precursors to form the target electrolyte. In one non-limiting example, selected precursors Li₂S and P₂S₅ are mixed in a THF solvent in a ratio of 3 moles of Li₂S to 1 mole of P₂S₅ (molar ratio of 3:1). During the mixing process the selected precursors Li₂S and P₂S₅ chemically react in the solvent to form the target Li₃PS₄. In another example, selected precursors Li₂S, P₂S₅, and LiCl are mixed in a para-xylene solvent and chemically react in the solvent to form the target Li₆PS₅Cl.

Examples of solvents that may be utilized to effectuate the reaction of sulfide-based SSE precursors to produce sulfide-based electrolytes include, but is not limited to, tetrahydrofuran (THF), 2-Methyltetrahydroturan (MeTHF), Dimethoxyethane (DME), para-xylene, anisole, Acetonitrile (ACN), tulene, heptane, Ethyl Acetate (EA), etc.

The binders that may be used for each of the embodiments of the Method 200 (200A, 200B, 200C, 200D), includes, but are not limited to, Nitrite Butadiene Rubber (NBR), Hydrogenated Nitrile Butadiene Rubber (HNBR), Polyvinylidene fluoride-hexafluoropropylene copolymer (PVDF-HFP), styrene-butadiene rubber (SBR), Polyvinylidene fluoride-trifluoropropene copolymer (PVDF-TFP), SEPTON plastics (e.g. Styrene-ethylene-ethylene-propylene-styrene (SEEPS), styrene-butadiene-styrene (SBS), Styrene Ethylene Butylene Styrene (SEBS), etc.).

In a non-limiting example of a coating slurry made by the above described methods includes 30 to 50 wt % of total solid content and 50 to 70% solvent. The total solid content includes precursors and one or more of a binder, electrode active material, and conductive carbon. The precursors, such as Li₂S and P₂S₅, are in a ratio of 8.0 wt % to 38 wt %, preferably 15 wt % to 30 wt %, of the total solid content. Li₂S and P₂S₅ are in a molar ratio of 7/3 to 3/1. The binder is in a ratio of 2.0 wt % to 10 wt %, preferably 3.0 wt % to 7 wt %, of the total solid content. The electrode active material, such as Si powder, is in a ratio of 60 wt % to 90 wt %, preferably 65 wt % to 80 wt %, of the total solid content. The slurry may also include 1 wt % to 8 wt % conductive carbons, preferably 2 wt % to 5 wt % preferred, of the total solid content.

The electrode active material for an anode composition may include Si:SEEPS:(Li₂S+P₂S₅) in a 70:5:25 ratio by weight. In which Li₂S/P₂S₅ is in a 3/1 molar ratio. The electrode active material for an cathode composition include LiNi_{0.5}Co_{0.2}Mn_{0.3}O₂ (NCM523):LPSCI:SP in a 5:4:0.4 ratio by weight.

In another non-limiting example, LiX (X=Cl, Br, I) and Li₂S may be added to the solvent to form argyrodite-type electrolytes (for instance, LiCl/Li₂S=1/1 molar ratio). In another yet non-limiting example, LiX, Li₂S and MS₂ (M=Si, Sn, Ge) may be added to the solvent to form lithium Si/Ge/Sn-phosphor sulfo-Halogen (LIMPSX).

FIGS. 7A, 7B, and 7C are performance graphs of a solid-state battery having a sulfide-based SSE anode made by the Method 200 compared to a solid-state battery having an anode made by the traditional method. The traditional method includes ball milling followed by adding solvents to make a coating slurry. FIG. 7A is the initial charge-discharge curves of the solid-state battery under 0.05 C rate. It shows the electrode with Method 200 can have slightly higher initial discharge capacity. FIG. 7B is the discharge tests of the battery under different discharge rates. It shows our Method 200 can result in a anodes having better discharge power capability, which originated from the improved conductivity within electrodes. FIG. 7C compares the room temperature cycling performance of batteries at 0.5 C. Method 200 permits good cycling stability.

Numerical data have been presented herein in a range format. “The term “about” as used herein is known by those skilled in the art. Alternatively, the term “about” includes +/−0.5%” of stated value. It is to be understood that this range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. While examples have been described in detail, those familiar with the art to which this disclosure relates will recognize various alternative designs and examples for practicing the disclosed method within the scope of the appended claims.

The description of the present disclosure is merely exemplary in nature and variations that do not depart from the general of the present disclosure are intended to be within the scope of the present disclosure. Such variations are not to be regarded as a departure from the spirit and scope of the present disclosure.

What is claimed is:

1. A method of making a solid-state electrode comprising:
selecting precursors capable of chemically reacting to form a target solid-state electrolyte (SSE);
mixing the selected precursors into a solvent to form a coating slurry, wherein the precursors reacts in the solvent to form the target SSE in the coating slurry;
applying the coating slurry onto a current collector; and
evaporating the solvent from the coating slurry on the current collector thereby leaving the target SSE coating on the current collector.

2. The method of claim 1, wherein the selected precursors is not subjected to a ball milling process.

3. The method of claim 1, further comprising mixing at least one of a binder, an electrode active material, and a conductive carbon into the solvent to form the coating slurry.

4. The method of claim 3, wherein the coating slurry comprises 30 weight percent (wt %) to 50 wt % of a solid content, wherein the solid content comprises the selected precursors and at least one of the binder, the electrode active material, and the conductive carbon.

5. The method of claim 4, wherein the solid content comprises:
8.0 wt % to 38 wt % of the selected precursor;
2.0 wt % to 10 wt % of the binder;
60 wt % to 90 wt % of the electrode active materials; and
1 wt % to 8 wt % of conductive carbon.

6. The method of claim 1, wherein the selected precursors are lithium sulfide (Li₂S) and phosphorus pentasulfide (P₂S₅) and the target SSE is Li₃PS₄.

7. The method of claim 6, further comprising a molar ratio of Li₂S to P₂S₅ of from 7:3 to 3:1.

8. The method of claim 6, further comprising mixing Li₂S and LiX into the solvent, wherein X is one of CI, Br, and I; and
wherein Li₂S and LiX react in the solvent to form an argyrodite-type electrolyte.

9. The method of claim 8, further comprising a molar ratio of Li₂S to LiX is 1:1.

10. The method of claim 6, further comprising mixing LiX, Li₂S, and MS₂ into the solvent, wherein M is selected from a group consisting of Si, Sn, and Ge; and
wherein LiX, Li₂S, and MS₂ react in the solvent to form lithium Si/Ge/Sn-phosphor Sulfo-Halogen (LiMPSX).

11. A method of making a sulfide-based solid-state electrode comprising:
dissolving a binder in a first solvent to produce a binder solution;
mixing sulfur-electrolyte precursors in a second solvent for greater than 2 hours, wherein the sulfur-electrolyte precursors reacts in the second solvent to produce a sulfur-electrolyte suspension;
mixing the binder solution with the sulfur-electrolyte suspension to form a binder sulfur-electrolyte suspension;
mixing a silicon powder and a third solvent into the binder sulfur-electrolyte suspension to form an electrode coating slurry;
applying the coating slurry onto a current collector; and
drying the coating slurry on the current collector at a temperature between 60° C. to 160° C., thereby leaving a sulfur-electrolyte coated current collector;
wherein the sulfur-electrolyte precursors includes Li₂S and P₂S₅; and
wherein the first solvent, the second solvent, and the third solvent comprises tetrahydrofuran (THF).

12. The method of claim 11, further comprising mixing a conductive carbon in the electrode coating slurry.

13. The method of claim 11, wherein Li₂S and P₂S₅ includes a molar ratio Li₂S:P₂S₅ of between 7:3 to 3:1.

14. The method of claim 12, wherein the coating slurry includes a total solid content of between 30 wt % to 50 wt %, wherein the solid content comprises of the Li₂S and P₂S₅, the binder, the Si powder, and the conductive carbon.

15. The method of claim 14, wherein the total solid content comprises:
15 wt % to 30 wt % of the Li₂S and P₂S₅;
65 wt % to 80 wt % of the Si powder;
3.0 wt % to 7 wt % of the binder; and
2 wt % to 5 wt % of the conductive carbon.

16. A method of making a sulfide-based solid-state anode electrode, comprising:
chemically reacting electrolyte precursors Li₂S and P₂S₅ in a solvent to produce a sulfide-based electrolyte, wherein the solvent is Styrene-ethylene-ethylene-propylene-styrene (SEEPS);
mixing in a Si powder to the solvent;
adding additional solvent to form an electrode coating;
applying the electrode coating to a copper foil; and
drying the electrode coated copper foil at a temperature between 80° C. to 160° C., thereby producing an electrode sheet having a sulfide-based solid-state electrolyte.

17. The method of claim 16, wherein Si, SEEPS, and Li₂S and P₂S₅ includes a weight ratio of 70:5:25.

18. The method of claim 16, wherein Li₂S and P₂S₅ includes a mole ratio of 3:1.

19. The method of claim 16, wherein Li₂S and P₂S₅ are not subjected to a ball-milling process.

20. The method of claim 16, wherein the electrode sheet having the sulfide-based solid-state electrolyte defines an anode electrode sheet.
